(19) United States
(12) Patent Application Publication
(10) Pub. No.: US 2007/0261104 A1
(43) Pub. Date: Nov. 8, 2007

(54) System and method for parental/supervisory control using software contained on fixed media

(76) Inventors: Elizabeth McIntyre, Closter, NJ (US); David James McIntyre, Closter, NJ (US)

Correspondence Address: Elizabeth McIntyre, 375 Demarest Avenue, Closter, NJ, 07624, US

(21) Appl. No.: 11/787,126

(22) Filed: Apr. 13, 2007

Related U.S. Application Data
(60) Provisional application No. 60/791,875, filed on Apr. 13, 2006.

(51) Int. Cl. G06F 7/00

(52) U.S. Cl. 726/4

(57) ABSTRACT

A method for communications access control using software contained on fixed media is disclosed. The access control method comprises the steps of: (1) providing the primary account owner with a unique fixed media with control function, (2) selecting members of a user group subject to communications access control by the primary account holder, and (3) enabling access to the communications networks at the authorized levels by the user group as permitted and controlled by the primary account owner.

This application is based on Provisional Application No. 60/791,875 filed on Apr. 13, 2006, the priority of which is claimed.

### BACKGROUND OF THE INVENTION

### Field of the Invention

This invention relates generally to networked communications.

### BRIEF DESCRIPTION OF THE DRAWING

FIG. 1 is a flowchart that illustrates the basic steps of the invention.

### SUMMARY OF THE INVENTION

This invention in its various embodiments effectively provides a system and method for parental/supervisory control of communication network/service access, using software contained on fixed media (e.g. CD). A controlled system and method of communication access among communicating devices (e.g. computer terminal, phone, PDA, game console, etc.) via software contained on fixed media is provided whereby a primary account user selects a group of secondary account users and controls the access level(s) and functionality of the secondary account users. The control function for the primary account holder is manifested in software unique to the fixed media provided for the primary user. The software loaded on the fixed media provided to secondary users will enable communication access under the direction/supervision of the primary user, and operates to interface with the software of the primary user.

### DETAILED DESCRIPTION OF THE INVENTION

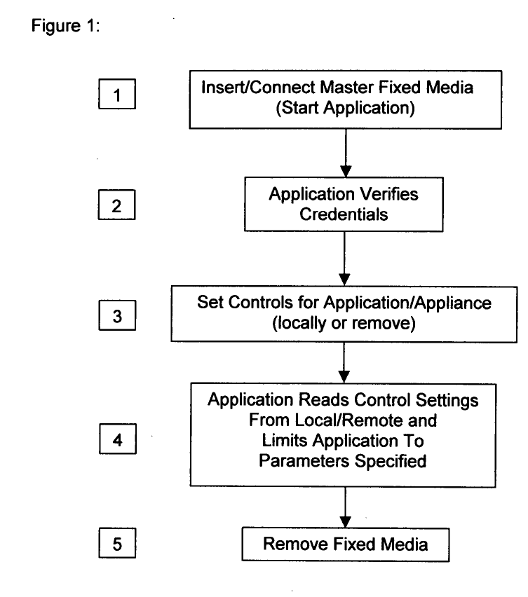

The invention in its various embodiments is further explained by reference to FIG. 1 which is a flowchart of the basic steps of the invention.

Step 1 shows the start of the application whereby the primary account user inserts/connects his/her unique master fixed media into a communication device.

Step 2 shows the application verifying credentials by authenticating and authorizing unique user identification data.

Step 3 shows the primary account user as he/she sets controls for application/appliance locally or remotely.

Step 4 shows the application/appliance reading control settings which limits application to parameters specified. This step illustrates the point at which communication between the primary account user and his/her secondary users can begin.

Step 5 shows the removal of the application from the communication device which effectively allows the parental/supervisory controls to be inaccessible by other users as the fixed media is literally removed.

Applied in a preferred embodiment of the invention, a web server is accessed by a Macromedia Flash projector contained on fixed media. Each user accesses his/her software via its provided fixed media and inserts that media into a communication terminal device (e.g. a computer) that has an interface to a communication network (e.g. internet or local intranet). The account identifier (e.g. account name or account number) is contained on the fixed media and each user has a separate account password that is entered at start-up. That user identification data is transferred by the Flash movie to the web server for authentication and authorization so that the group of users can communicate with each other in the way that is allowed for the account. Only the primary account user via his/her fixed media has access to the parental/supervisory control settings for the account. The software may contain any number of communication modes such as chat, instant/text messaging, video and audio conferencing, etc. In this preferred embodiment, a combination of client-server architecture, a multi-level “master/slave” protocol and a user interface window enables the primary user to set, alter and manage the access level(s) and functionality of the group of secondary users.

In one illustration of the above embodiment, the primary account user (e.g. a parent/team coach) can set the functionality of an adult secondary account user (e.g. grandparent/assistant coach) via his/her fixed media and allow the adult secondary user to have limited control over the other secondary account users (e.g. children/team players). For example, the parent/coach may want to allow the children/players to communicate in chat mode monitored by the grandparent/assistant coach without the parent/coach's active presence while at the same time, allowing the children/players to read and leave messages to each other without monitoring.

Setting the access levels in this manner offers the parent a comprehensive control beyond what is currently available in chat and messaging environments. The ability for a parent to control and manage the settings of the children's accounts via his/her fixed media offers increased security. Because children and parents have their own software on fixed media, children have no access to the parental controls. By contrast, in typical chat and messaging programs having “parental controls”, children can access the parent's control settings and alter them without the express knowledge of the parent simply because these programs are typically stored and accessed directly on the communication terminal device (e.g. computer) rather than separate fixed media.

The above instance is illustrative and not restrictive. The invention may be embodied in many variations with potential for numerous applications.

We claim:

1. A method for communications access control comprising the steps of selecting members of a user group subject to communications access control; determining authorized access levels to one or more communications network for ones of the selected user group; and enabling communication devices for said ones of said user group for access to said communications networks at said authorized levels.
